(19) United States
(12) Patent Application Publication
(10) Pub. No.: US 2009/0122373 A1
(43) Pub. Date: May 14, 2009

(54) Image Processing Apparatus

(75) Inventor: Satoshi OKAMOTO, Kyoto-shi (JP)

Correspondence Address: HOGAN & HARTSON L.L.P., 1999 AVENUE OF THE STARS, SUITE 1400, LOS ANGELES, CA, 90067, US

(73) Assignee: MURATA MACHINERY, LTD., Kyoto-shi (JP)

(21) Appl. No.: 12/235,027

(22) Filed: Sep. 22, 2008

(30) Foreign Application Priority Data
Nov. 9, 2007 (JP) 2007-291816

(51) Int. Cl. H04N 1/46; H04N 1/41

(52) U.S. Cl. 358/539; 358/426.01

(57) ABSTRACT

An image processing apparatus includes a first image reduction unit that creates reduced-image data from image data, a coding unit that creates a reduced-image file from the reduced-image data, a memory unit that stores the reduced-image file in association with an original-image file created from the original image, a display unit that displays the content of the reduced-image file, a display controller that controls the display unit, a transfer unit that transfers the reduced-image file read out from the memory unit to the display controller, and a conversion unit that converts the content of the reduced-image file transferred to the display controller into signals to display on the display unit.

### CROSS-REFERENCE TO RELATED APPLICATIONS

This application claims priority under 35 U.S.C 119 to Japanese Patent Application No. 2007-291816, filed on Nov. 9, 2007, which application is hereby incorporated by reference in its entirety.

### BACKGROUND OF THE INVENTION

1. Field of the Invention

The present invention relates to an image processing apparatus and, in particular, to an image processing apparatus that can display thumbnail-size images on a display unit.

2. Description of the Related Art

A well-known image processing apparatus, such as a facsimile machine, includes a display unit that can display various pieces of information and thumbnail-size images of an image file stored in the image processing apparatus, etc. When the thumbnail-size images are displayed on the display unit, a user can rapidly grasp the received content of facsimile, or the like.

Such a facsimile machine associates original image data and thumbnail-size images with each other in advance, stores the data and images in a Secure Digital (SD) memory card, and reads out only the thumbnail-size images from the SD memory card to display on a Liquid Crystal Display (LCD). Another conventional facsimile machine stores original image data for polling and image data for thumbnail display in association with each other. When a request for thumbnail-size images is made by a communication destination, the facsimile machine generates an image of a page on which the thumbnail-size images are arranged, and transmits the image to the destination.

In such image processing apparatuses, the data size of original images to be processed is substantially increasing along with recent high-quality picture technologies, and the calculation cost for creating the thumbnail-size images is also increasing. It is desirable that the user be able to give instructions regarding the number of thumbnail-size images to be displayed at a time on the display unit and a reduction ratio of each thumbnail-size image, or the like.

However, processes of creating thumbnails, transferring corresponding thumbnail-size image data to the display unit, and displaying the data are not known in detail.

### SUMMARY OF THE INVENTION

In order to overcome the problems described above, embodiments of the present invention provide an image processing apparatus that can create thumbnail-size images and reduce an amount of time required for processes of transferring the thumbnail-size images to a display unit and displaying the images.

According to an embodiment of the present invention, an image processing apparatus includes a first image reduction unit, a coding unit, a memory unit, a display unit, a display controller, a transfer unit, and a conversion unit. The first image reduction unit creates reduced-image data from original-image data. The coding unit creates a reduced-image file from the reduced-image data. The memory unit stores the reduced-image file in association with an original-image file created from the original-image data. The display unit displays the content of the reduced-image file. The display controller controls the display unit. The transfer unit transfers the reduced-image file read out from the memory unit to the display controller. The conversion unit converts the content of the reduced-image file transferred to the display controller into signals to display on the display unit.

In the above-described embodiment, since the display controller that controls the display unit is connected via the transfer unit, the burden in processes can be divided. Moreover, since the reduced-image data reduced by the reduction unit is transferred to the display controller by the transfer unit, a transferring period of time can be reduced by reducing an amount of transfer data, and the burden in communication of the transfer unit can also be reduced.

According to an embodiment of the present invention, a second image reduction unit is provided to further reduce the content of the transferred reduced-image file, and to display the reduced content.

In the above-described embodiment, when displaying the content of the reduced-image file on the display unit, the content can be displayed in a further reduced state in accordance with its usage and circumstances. Since the image data once reduced by the image reduction unit is further reduced by the second image reduction unit, the burden on the second image reduction unit can be reduced.

According to an embodiment of the present invention, the second image reduction unit can change an image size that has been reduced. In accordance with the image size reduced by the second image reduction unit, the display controller can change the number of reduced images to be displayed on the display unit.

When viewing the images in detail, a size of thumbnail-size images is enlarged, and the images are displayed on the display unit. When viewing the images in a view format, the size of thumbnail-size images is reduced, a number of images are displayed, and a user can effectively find the desired image file.

According to an embodiment of the present invention, the transfer unit includes a serial interface. Since a serial interface having a high transfer rate is used, the transfer period of time can be further reduced. Moreover, even when an amount of image data to be transferred is large, the data can be smoothly transferred.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 is a block diagram illustrating a configuration of a Multi-Function Peripheral (MFP) according to an embodiment of the present invention.

FIG. 2 is a flow chart illustrating an operation of creating a file of reduced images at the time of scanning an original document.

FIG. 3 is a flow chart illustrating an operation of creating a file of reduced images at the time of receiving a facsimile.

FIG. 4 is a flow chart illustrating an operation of displaying thumbnail-size images on an LCD based on the file of reduced images.

### DETAILED DESCRIPTION OF PREFERRED EMBODIMENTS

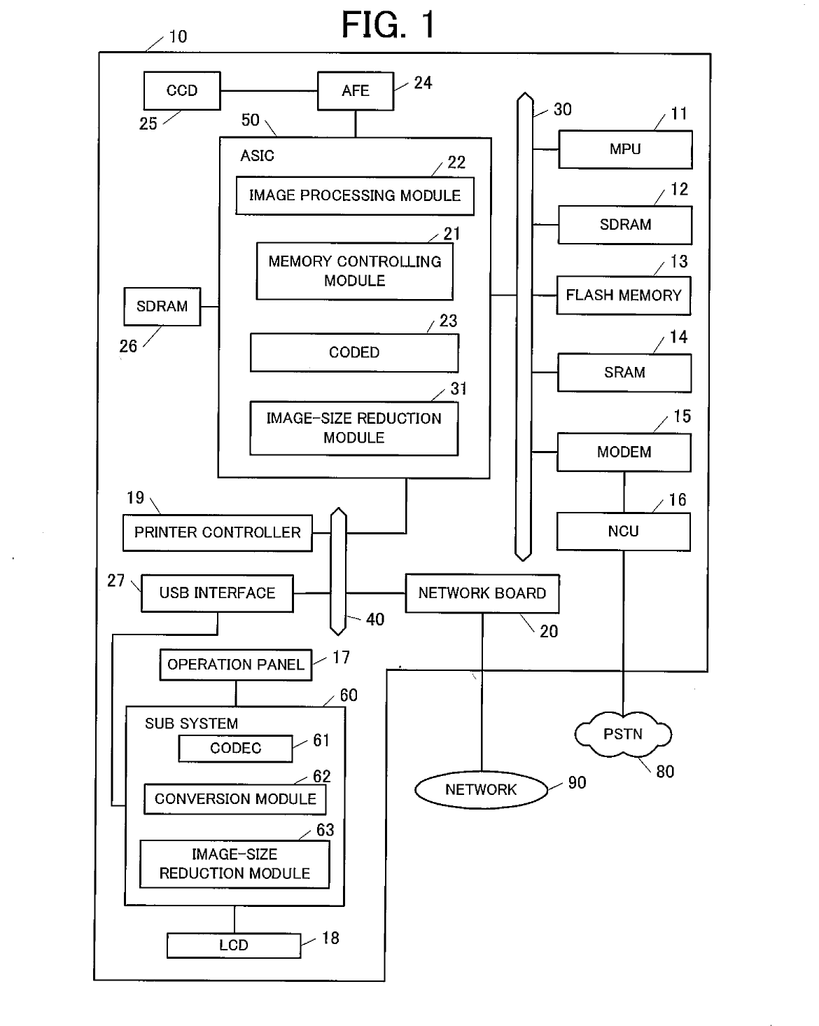

An embodiment of the present invention will be described with reference to the drawings. FIG. 1 is a block diagram illustrating an electrical configuration of an MFP 10 according to an embodiment of the present invention.

As illustrated in FIG. 1, the MFP 10 of the present embodiment includes a Micro Processing Unit (MPU) 11, a Synchronous Dynamic Random Access Memory (SDRAM) 12, and a flash memory 13. The MPU 11, the SDRAM 12, and the flash memory 13 are connected with each other via a local bus 30.

The MPU 11 is a control unit that controls the entire MFP 10. The MPU 11 reads out and executes various programs stored in the flash memory 13, and implements a facsimile function, a scanner function, and a copier function, or the like, to be described later.

A Static RAM (SRAM) 14 and a modem 15 are connected to the local bus 30. The SRAM 14 stores various user settings such as a speed dial, and the stored content is backed up by a battery. The modem 15 includes a function of modulating data into an audio frequency signal and a function of demodulating the audio frequency signal into data. The modem 15 is connected with a Network Control Unit (NCU) 16. The NCU 16 is connected with a Public Switched Telephone Network (PSTN) 80, and can communicate with a destination via facsimile.

The MFP 10 includes a Peripheral Component Interconnect (PCI) bus 40. The local bus 30 is connected to the PCI bus 40 via an Application Specific Integrated Circuit (ASIC) 50, which is provided for performing image processing of the present embodiment. The MPU 11 exchanges data via the ASIC 50 with various apparatuses connected to the PCI bus 40.

A Charge Coupled Device (CCD) 25 is connected with the ASIC 50 via an Analog Front End (AFE) 24. The CCD 25 is a part of an original document scanning unit. An image signal of an original document scanned by the CCD 25 is converted by the AFE 24 from an analog signal to a digital signal, and input into the ASIC 50. The CCD 25 includes a color filter that separates three primary colors, and can scan color original documents.

An SDRAM 26 that functions as an image memory is connected with the ASIC 50. The SDRAM 26 stores data coded by the ASIC 50, or the like.

The ASIC 50 will be described next. The ASIC 50 includes a memory controlling module 21, an image processing module 22, a coder and decoder (CODEC) module 23, and an image-size reduction module 31, or the like. The ASIC 50 also includes an ASIC controlling module and a Direct Memory Access (DMA) controlling module that control the memory controlling module 21, the image processing module 22, the CODEC 23, and the image-size reduction module 31, etc., and exchange data between the local bus 30 and the PCI bus 40.

The image processing module 22 performs processes of shading correction, gamma correction, and edge enhancement, or the like, on multiple-tone Red-Green-Blue (RGB) format image data that is input from the CCD 25. The RGB format image data is converted into a YCbCr format by a color conversion module of the ASIC 50.

The memory controlling module 21 receives image data processed by the image processing module 22, and executes various processes such as rotating images for adjusting printing and paper directions and reduction for combined copy, or the like, in accordance with user settings.

The CODEC 23 compresses or expands image data by using a well-known compression format such as Modified Haffman (MH), Modified Read (MR), Modified MR (MMR), and a Joint Photographic Experts Group (JPEG). The CODEC 23 codes image data of scanned original documents, or decodes image data received via facsimile communication.

The image-size reduction module 31 creates reduced-image data, which corresponds to thumbnail-size images to be displayed on an LCD 18. The reduced-image data is coded by the CODEC 23, and a file of reduced images is created. The creation and display of the thumbnail-size images will be described later.

An option unit, such as a printer controller 19 and a network board 20, is connected to the PCI bus 40. The printer controller 19 adds a printer function to the MFP 10, converts a Page Description Language (PDL) received from a personal computer (PC) or the like connected with the MFP 10 into raster data, and prints images on a sheet of paper by using an image forming unit provided in the MFP 10. The network board 20 connects the MFP 10 with a network 90 so as to communicate with other nodes in accordance with the Transmission Control Protocol/Internet Protocol (TCP/IP). The printer controller 19 and the network board 20 implement a network printing function that receives the PDL from the PC connected with the network 90, and prints images based on the PDL.

A Universal Serial Bus (USB) interface 27 is connected to the PCI bus 40. A USB device can be connected to the USB interface 27. In the MFP 10 of the present embodiment, the LCD 18 is connected to the USB interface 27 via a sub system 60. The USB interface 27 includes a USB host controller, and operates the USB device by communicating with a function controller of the connected sub system 60.

The USB interface 27 of the present embodiment is capable of high-speed communication and is compatible with a USB 2.0 High Speed mode. The sub system 60 and the MPU 11 can mutually communicate via the USB interface 27.

The MFP 10 includes an operation panel 17 that is connected to the sub system 60. The operation panel 17 includes various keys such as a numeric keypad, a cursor key, a start key, and a cancel key. A user uses these keys to conduct copying and facsimile transmission operations, or the like. By communicating with the sub system 60, the MPU 11 recognizes the operation content of the operation panel 17, and performs various processes accordingly.

The color LCD 18 represents light intensities of red, green, and blue in 256 shades (i.e., uses a true color method), and adopts an RGB calorimetric system that enables various color displays by combining each color. The content and instructions of various operations are displayed in characters and graphics, etc., on a screen of the color LCD 18.

The sub system 60 is a micro computer that includes a Central Processing Unit (CPU), or the like, and controls the LCD 18. The sub system 60 communicates via the USB interface 27 with the MPU 11 arranged on a main body side of the MFP 10, exchanges data, such as content to be displayed on the LCD 18, and displays the content on the LCD 18 accordingly.

According to the present embodiment, the sub system 60 includes a CODEC 61, a conversion module 62, and an image-size reduction module 63, all of which are provided for displaying thumbnail-size images on the LCD 18. The CODEC 61 decodes a file of reduced images for thumbnails transferred via the USB interface 27.

If necessary, the image-size reduction module 63 further reduces the data of reduced images that have been reduced by the image-size reduction module 31 arranged on a side of the ASIC 50.

The conversion module 62 performs conversion of data format to display the decoded data of reduced images (i.e., the data of re-reduced images) on the LCD 18. The file of reduced images is represented in the YCbCr format that represents colors by a luminance signal (Y) and a color-difference signal (CbCr). On the other hand, since the LCD 18 adopts the RGB format, in order to display images, it is necessary to input image data in the RGB format. Therefore, the conversion module 62 performs commonly-known calculations to convert image data in the YCbCr format of the file of reduced images into image data for display in the RGB format.

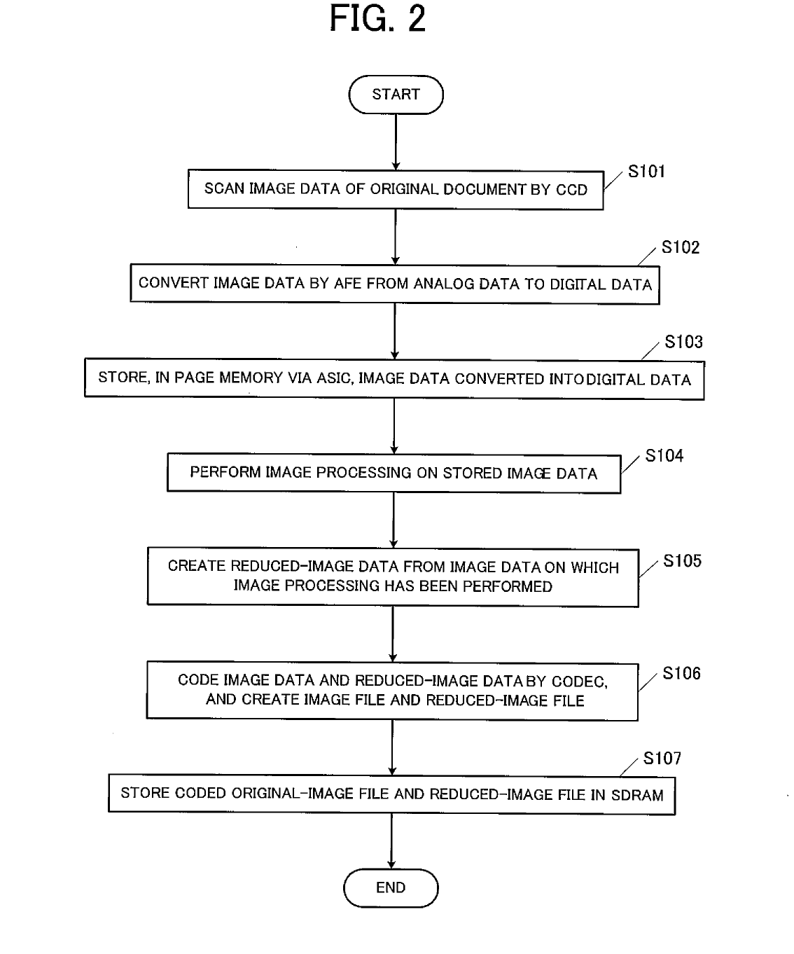

With reference to FIG. 2, the storage of data of reduced images performed at the time of scanning an original document will be described. FIG. 2 is a flow chart illustrating an operation performed at the time of scanning an original document.

As illustrated in FIG. 2, when the user instructs the MFP 10 to scan, image data of an original document is scanned by the CCD 25 in an original document scanning unit (S101). The scanned image data is converted by the AFE 24 from analog data into digital data (S102). The image data converted into digital data is temporarily stored, via the ASIC 50, in the SDRAM 26 that defines a page memory (S103).

The image processing module 22 of the ASIC 50 performs image processing, such as shading correction, gamma correction, and edge enhancement, on the image data stored in the SDRAM 26 (S104).

When the image processing of S104 is completed, the size of the original image data is reduced to one-half or one-fourth, and reduced-image data is created (S105). By fixing the reduction ratio to one-half or one-fourth, the burden on the image reducing process is reduced, and the process can be executed in a short period of time. The reduced image data created in this process is used, as described later, as original data for creating thumbnail-size images to be displayed on the LCD 18.

The original image data and the reduced image data are coded by the CODEC 23, and an original-image file and a reduced-image file in a JPEG format are created (S106). The JPEG file includes marker information, and the reduced-image file and the original-image file are associated with each other based on the marker information. The created original-image and reduced-image files are stored in the SDRAM 26 (S107). The coding of the reduced-image file is not limited to the JPEG format, but may adopt other commonly-known image formats (such as a Graphics Interchange Format (GIF), a Tagged Image File Format (TIFF), and a Portable Network Graphics (PNG)).

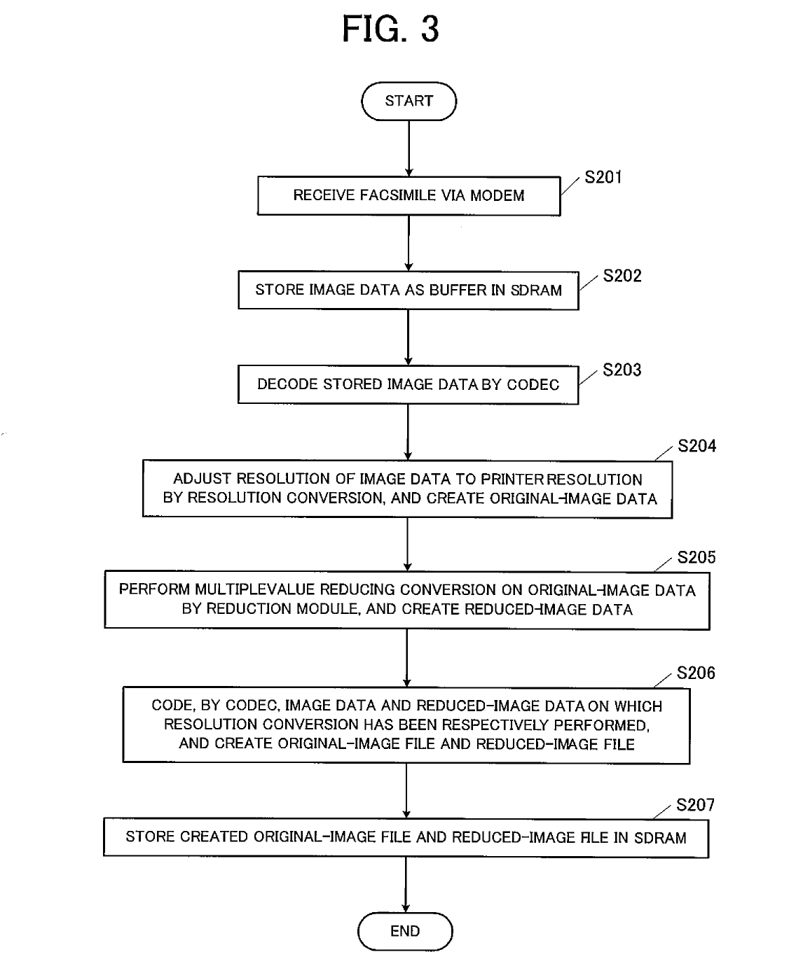

With reference to FIG. 3, the storage of the reduced-image data performed when a facsimile is received will be described. FIG. 3 is a flow chart illustrating an operation performed at the time of facsimile reception.

When the modem 15 of the MFP 10 receives via the PSTN 80 a facsimile message (S201), image data is temporarily stored in the SDRAM 26 as a buffer by the ASIC 50 (S202). The received image data is decoded by the CODEC 23 (S203). Then, a resolution is converted by the image processing module 22 of the ASIC 50 so as to be adjusted to a resolution of the printer, and original-image data is created (S204).

When the resolution converting process of S204 is completed, reduced-image data is created from the received image data (S205). Similarly to the time of document scanning, the reduced-image data is created in a size of one-half or one-fourth of the original-image data. When the image data received by facsimile is black-and-white binary data, the image data is converted into multivalued data (gray scale) by the image reducing process. By this multivalue reducing process, reproducibility of the displayed content of the thumbnail-size images on the LCD 18 is improved compared with a case in which a binary-to-binary reducing process is performed.

The original-image file and the reduced-image file are then separately created from the original-image data and the reduced-image data (S206). In the present embodiment, the original-image data is coded in the MMR format, and the reduced-image data is coded in the JPEG format. The original-image and reduced-image files are stored in the SDRAM 26 (S207). Information for associating the reduced-image file with the original-image file is described in a marker and/or tag portion of the reduced-image file.

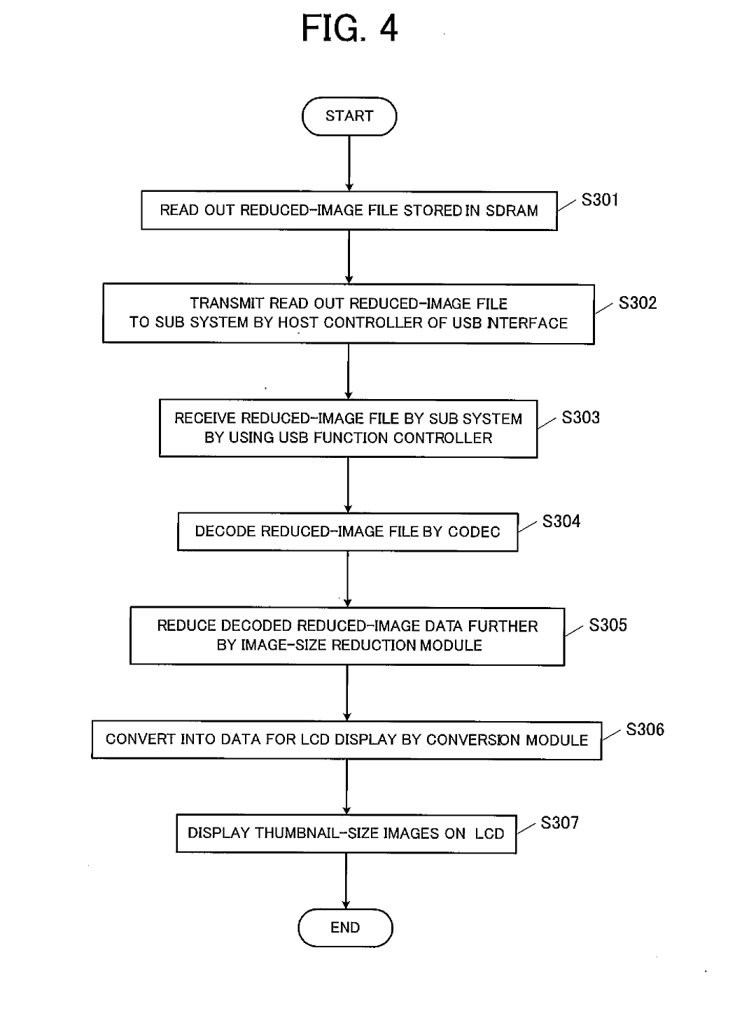

With reference to FIG. 4, an operation flow on the side of the LCD 18 will be described. FIG. 4 is a flow chart illustrating an operation in which the thumbnails are displayed on the LCD 18.

When the user operates the operation panel 17 to display the thumbnail-size images, the MFP 10 reads out the reduced-image file from the SDRAM 26 (S301). Then, when the USB host controller of the USB interface 27 communicates with the USB function controller of the sub system 60, the reduced-image file is transferred to the side of sub system 60 (S302, S303).

Having received the reduced-image file, the sub system 60 decodes the reduced-image file and acquires the reduced-image data by using the CODEC 61 (S304). The acquired reduced-image data is further reduced, if necessary, by the image-size reduction module 63 (S305).

The further reduced data for display is converted by the conversion module 62 from the YCbCr format to the RGB format for LCD display (S306). Thus, the content of the converted reduced-image data for display is displayed on the LCD 18 (S307). The user of the MFP 10 references the displayed thumbnail-size images, selects a desired image by using the operation panel 17, and performs a printing instruction and facsimile transmission, or the like.

In accordance with instructions from the user, the MFP 10 (the sub system 60) of the present embodiment can change the size and number of thumbnail-size images to be displayed on the LCD 18. For example, selection can be made between a display on the LCD 18 in which a list of three large-size thumbnail images in a row and two large-size thumbnail images in a column, i.e., six of them in total, is displayed, and a display on the LCD 18 in which a list of five small-size thumbnail images in a row and three small-size thumbnail images in a column, i.e., 15 of them in total, are displayed. The size selection of the thumbnail-size images can be performed by changing the reduction ratio (the image size after the reduction) by the image-size reduction module 63 in the process of S305 of FIG. 4.

As described above, the MFP 10 of the present embodiment includes the image-size reduction module 31, the CODEC 23, the SDRAM 26, the LCD 18, the sub system 60, the USB interface 27, and the conversion module 62. The image-size reduction module 31 creates the reduced-image data from the original-image data. The CODEC 23 creates the reduced-image file from the reduced-image data. The SDRAM 26 stores the reduced-image file in association with the original-image file created from the original-image data. The LCD 18 displays the content of the reduced-image file. The sub system 60 controls the LCD 18. The USB interface 27 transfers to the sub system 60 the reduced-image file read out from the SDRAM 26. The conversion module 62 converts the content of the reduced-image file transferred to the sub system 60 into signals in the RGB format to display on the LCD 18.

Since the sub system 60, which controls the LCD 18, is connected via the USB interface 27, the burden on the processes can be divided, thereby reducing the burden on the MPU 11, or the like. Moreover, since the reduced-image data reduced by the image-size reduction module 31 is transferred to the sub system 60 by the USB interface 27, a transferring period of time can be reduced by reducing an amount of transfer data, and the communication burden on the USB interface 27 can be also reduced.

The MFP 10 of the present embodiment includes the image-size reduction module 63 to further reduce the content of the transferred reduced-image file and display the content.

When displaying the content of the reduced-image file on the LCD 18, by the image-size reduction module 63, the content can be displayed in a further reduced state in accordance with its usage and circumstances, or the like. Moreover, since the image data that has been once reduced by the image-size reduction module 31 is further reduced by the image-size reduction module 63, the burden on the image-size reduction module 63 is reduced compared with the case in which the original image data is directly reduced, and the thumbnail-size images can be displayed in a short period of time.

In the MFP 10 of the present embodiment, the image-size reduction module 63 can change an image size that has been reduced. Moreover, the sub system 60 can change the number of reduced images to be displayed on the LCD 18, in accordance with the image size reduced by the image-size reduction module 63.

In such a configuration, if the user desires to view the images in detail, the size of the thumbnail images to be displayed on the LCD 18 is enlarged. If the user desires to view the images in a list, the size of the thumbnail images is reduced so that a number of images are displayed, and the user can effectively find the desired image file.

In the MFP 10 of the present embodiment, the reduced-image file is transferred to the sub system 60 via the USB interface 27.

In such a configuration, since a serial interface, of which the transferring rate is high, is used, a transferring period of time can be further reduced. Moreover, the serial interface can smoothly transfer data even when a data amount of the images to be transferred is large.

An embodiment of the present invention has been described above and may be modified in various ways such as described below.

In the above-described embodiment, various operations are performed by using the operation panel 17. Alternatively, the LCD 18 may adopt a commonly-known touch screen, and thus the various operations may be performed by touching the LCD 18. Moreover, other systems, such as an Electro-Luminescence (EL) display, a Plasma display, and a Cathode Ray Tube (CRT) may be adopted in place of the LCD.

In the above-described embodiment, as illustrated in FIG. 2, when an original document is scanned, image processing such as shading correction normally performed at the time of image scanning is performed by the image processing module 22, and then the reducing process of the image is performed (S104, S105). However, the order of the process may be changed, and normal image processing may be performed after the reducing process.

An ASIC for performing shading correction etc., and an ASIC for performing the image reducing process may be separately provided and modified such that the processes of S104 and S105 of FIG. 2 are performed in parallel. A codec for coding the original-image data and a codec for coding the reduced-image data may be separately provided and modified such that the original-image data and reduced-image data are coded in parallel.

In the above-described embodiment, monochrome, bi-level facsimile data is received and processed. However, color facsimile data may alternatively be received. In such a case, color thumbnail-size images may be displayed by creating color reduced images by the image-size reduction module 31 of the ASIC 50 and the image-size reduction module 63 of the sub system 60.

In the above-described embodiment, a CCD 25 capable of scanning color original documents is provided. Alternatively, a monochrome CCD may be provided.

The above-described embodiment is not limited to a copy-and-facsimile MFP 10, and may be applied to a copier, a facsimile machine, and an image scanner, or the like, all of which include a copy function independently. Further, the above-described embodiment may be applied to other image processing apparatuses that include a display unit and can input or acquire image data.

While the present invention has been described with respect to embodiments thereof, it will be apparent to those skilled in the art that the disclosed invention may be modified in numerous ways and may assume many embodiments other than those specifically set out and described above. Accordingly, the appended claims cover all modifications that fall within the true spirit and scope of the present invention.

What is claimed is:

1. An image processing apparatus comprising:
a first image reduction unit that creates reduced-image data from image data;
a coding unit that creates a reduced-image file from the reduced-image data;
a memory unit that stores the reduced-image file in association with an original-image file created from the image data;
a display unit that displays a content of the reduced-image file;
a display controller that controls the display unit;
a transfer unit that transfers to the display controller the reduced-image file read out from the memory unit; and
a conversion unit that converts the content of the reduced-image file transferred to the display controller to signals to display on the display unit.

2. The image processing apparatus according to claim 1 further comprising a second image reduction unit that further reduces the content of the transferred reduced-image file to display the reduced content.

3. The image processing apparatus according to claim 2, wherein the second image reduction unit changes an image size that has been reduced, and in accordance with the image size reduced by the second image reduction unit, the display controller changes the number of reduced images to be displayed on the display unit.

4. The image processing apparatus according to claim 1, wherein the transfer unit is a serial interface.

5. The image processing apparatus according to claim 4, the serial interface is a Universal Serial Bus.

6. The image processing apparatus according to claim 1 further comprising a resolution conversion unit that converts facsimile image data into original-image data having a high resolution.

7. The image processing apparatus according to claim 6, wherein when the image data is monochrome bi-level data, the first image reduction unit reduces the data by converting the data into gray scale image data.

8. The image processing apparatus according to claim 1, wherein the display unit displays color images and color reduced images.

9. The image processing apparatus according to claim 8 further comprising a calorimetric system conversion unit that converts the image data from a YCbCr calorimetric system to a Red-Green-Blue calorimetric system.

10. The image processing apparatus according to claim 9, wherein the reduced-image file is a file of Joint Photographic Experts Group, and the display controller creates YCbCr image data from the reduced-image file.

11. An image processing apparatus comprising:
means for creating first reduced-image data from image data;
means for creating a reduced-image file from the first reduced-image data;
means for storing the reduced-image file in association with an original-image file created from the image data;
means for displaying a content of the reduced-image file on a display unit;
means for transferring the reduced-image file stored in a memory unit; and
means for converting the content of the transferred reduced-image file into signals to display.

12. The image processing apparatus according to claim 11 further comprising means for creating second reduced-image data by further reducing the content of the transferred reduced-image file.

13. The image processing apparatus according to claim 12 further comprising means for changing a reduction ratio of the second reduced-image data so as to display a plurality of reduced images on the display unit.

14. The image processing apparatus according to claim 13, further comprising means for transferring the reduced-image file to a serial interface.

15. The image processing apparatus according to claim 14 further comprising means for controlling a Universal Serial Bus interface to transfer the data to the serial interface.

16. The image processing apparatus according to claim 11 further comprising means for converting facsimile image data into original-image data having a high resolution.

17. The image processing apparatus according to claim 16 further comprising means for reducing the data, when the image data is monochrome bi-level image data, by converting the data into gray scale image data.

18. The image processing apparatus according to claim 17 further comprising means for displaying the second reduced-image data in color.

19. The image processing apparatus according to claim 18 further comprising means for converting the image data from a YCbCr calorimetric system to a Red-Green-Blue colorimetric system.

20. The image processing apparatus according to claim 19 further comprising means for creating YCbCr image data from the reduced-image file of Joint Photographic Experts Group format.
